(19) United States
(12) Patent Application Publication
(10) Pub. No.: US 2010/0219957 A1
(43) Pub. Date: Sep. 2, 2010

(54) LIGHTED SURROUND

(75) Inventors: Mark W. Jolley, Carlsbad, CA (US); Victor Lee Walker, Murietta, CA (US); James Hedgecock, Vista, CA (US)

Correspondence Address: FITCH EVEN TABIN & FLANNERY, 120 SOUTH LASALLE STREET, SUITE 1600, CHICAGO, IL, 60603-3406, US

(73) Assignee: Dimension One Spas, Inc., Vista, CA (US)

(21) Appl. No.: 12/650,307

(22) Filed: Dec. 30, 2009

Related U.S. Application Data
(60) Provisional application No. 61/141,604, filed on Dec. 30, 2008.

(51) Int. Cl. G08B 17/12; E05B 17/10

(52) U.S. Cl. 340/600; 362/100

(57) ABSTRACT

Lighted surrounds for door handles are provided where the lighted surround can help identification of the door handle, such as when the lights in the room are off or dimmed. The lighted surrounds may be made at least partially of a translucent, flexible elastomeric material and may include one or more light sources and a power source.

### CROSS REFERENCE TO RELATED APPLICATION

This application claims priority from U.S. Pat. Appl. Ser. No. 61/141,604, filed on Dec. 30, 2008, which is hereby incorporated by reference in its entirety.

### FIELD

This disclosure relates to lighted surrounds, and in particular to lighted surrounds for use with items that are at least partially insertable into or through an opening in another item or with handles and knobs.

### BACKGROUND

Door handles are often used for access to rooms where the lights in the room may not always be on. In such rooms, it can be difficult to access the door handle and thus open the door when the lights in the room are not on. This can be particularly exacerbated when the room is not familiar. For example, the door handle of a hotel room may be difficult to locate when the lights in the room are off. This can be a problem when emergency exit from the hotel room is required, such as in the case of a fire.

### SUMMARY

Lighted surrounds for door handles are provided where the lighted surround can improve identification of the door handle, such as when the lights in the room are off or dimmed. The lighted surrounds may be in the form of a sleeve that fits over the door handle. The lighted surrounds may alternatively be in the form of an intermediate gasket or the like that is positioned between the door and a portion of the door handle assembly. Both forms of the lighted surrounds may be made at least partially of a translucent, flexible elastomeric material and may include one or more light sources and a power source. The lighted surrounds may be always on, may be controlled by a light detector, may be controlled by larger system, such as an alarm system, and/or may be controlled by touch.

In one aspect, the lighted surround may include a sleeve that is configured to stretch to fit around a door handle, which can include a knob or lever-type door handle, and then remain secured to the door handle. The sleeve includes one or more internal light sources, such as LEDs, that can be powered either by an internal power source, such as a battery, or an external power source, such as being hard-wired to the electrical system of a building. The light sources and power source, if the latter is internal, are preferably positioned within the sleeve so as to not interfere with application and removal of the sleeve from the handle. Further, some or all of the electrical components may be accessible from the interior of the sleeve and not the exterior, such as to permit replacement while not interfering with presenting an uninterrupted exterior surface for grasping.

In another aspect, the lighted surround may be positioned between an exterior portion of the door handle assembly and the door, on one or optionally both sides of the door. The lighted surround may include a hollow body portion for positioning inside of a door and one or two outer flanges for positioning adjacent exterior surfaces of the door. The body portion can include an opening in a sidewall to permit components of the door handle assembly, such as components for operating a latch, to pass therethrough. A recess can be provided in the flange for receiving a light source. The light source can be powered by an internal power source, such as a battery, or an external power source, such as being hard-wired to the electrical system of a building. In the case of an internal power source, the body can be adapted to hold the source in one of a plurality of different locations, thereby permitting flexibility to adapt the lighted surround to accommodate different types of door handle assemblies.

### BRIEF DESCRIPTION OF THE DRAWINGS

FIG. 1 is a partial perspective view of a door handle assembly having a lighted surround adjacent a door to which the door handle assembly is mounted;

FIG. 2 is a cross-sectional view of the door handle assembly and lighted surround of FIG. 1 showing internal components within a door and a light source and power source for the light source of the lighted surround taken along line 2-2 of FIG. 1;

FIG. 3 is a side elevation view of the lighted surround of FIG. 1 showing an opening in a sidewall thereof;

FIG. 4 is a cross-sectional view of the lighted surround of FIG. 3 taken along line 4-4 and showing the opening in the sidewall;

FIG. 5 is a cross-sectional view of the lighted surround of FIG. 3 taken along line 5-5 and showing the light source;

FIG. 6 is a partial perspective view of a door handle assembly having a lighted surround over the door handle;

FIG. 7 is a side elevation view of the lighted surround of FIG. 6;

FIG. 8 is a cross-sectional view of the lighted surround of FIG. 7 taken along line 8-8 and showing a plurality of light sources and a power source for the light sources;

FIG. 9 is a perspective view of a lighted surround positionable around a door knob and having a battery compartment containing a battery and a light insert;

FIG. 10 is a bottom plan view of the lighted surround of FIG. 9;

FIG. 11 is a top plan view of the lighted surround of FIG. 9;

FIG. 12 is a cross-sectional view of the lighted surround of FIG. 9 taken along line 12-12 of FIG. 11 and showing a battery and light insert disposed in the battery compartment and the battery compartment closed by a removable cover;

FIG. 13 is a perspective view of the lighted surround of FIG. 9 with the battery and light insert being removed from the battery compartment;

FIG. 14 is a cross-sectional view of the lighted surround of FIG. 9 with the battery and light insert being removed from the battery compartment taken along line 14-14 of FIG. 13;

FIG. 15 is a perspective view of the battery and attached light insert of FIG. 12; and

FIG. 16 is a top plan view of the battery and attached light insert of FIG. 15.

### DETAILED DESCRIPTION OF THE DRAWINGS

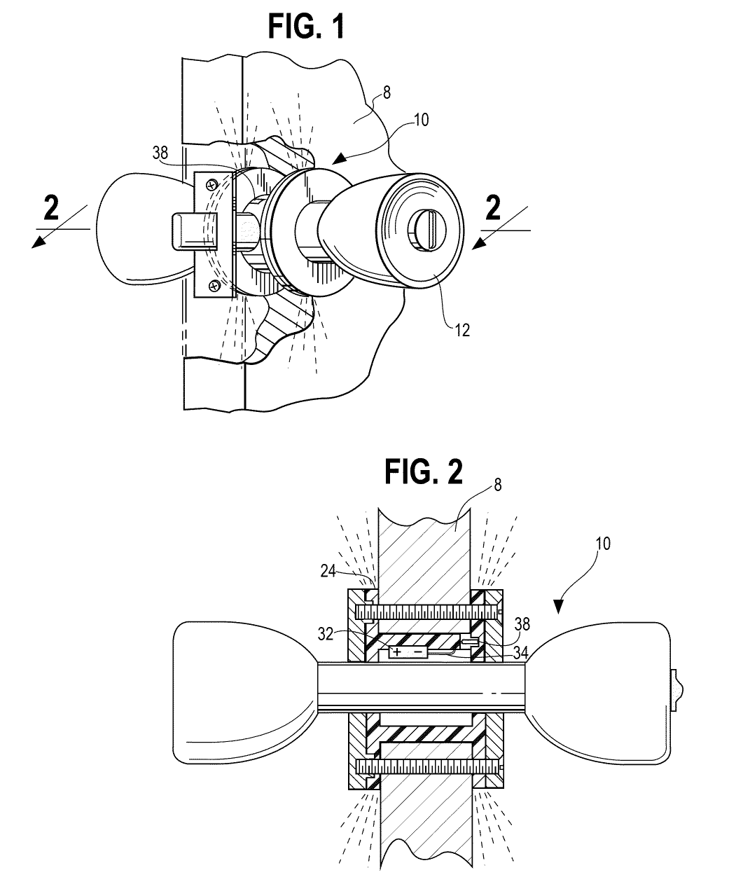

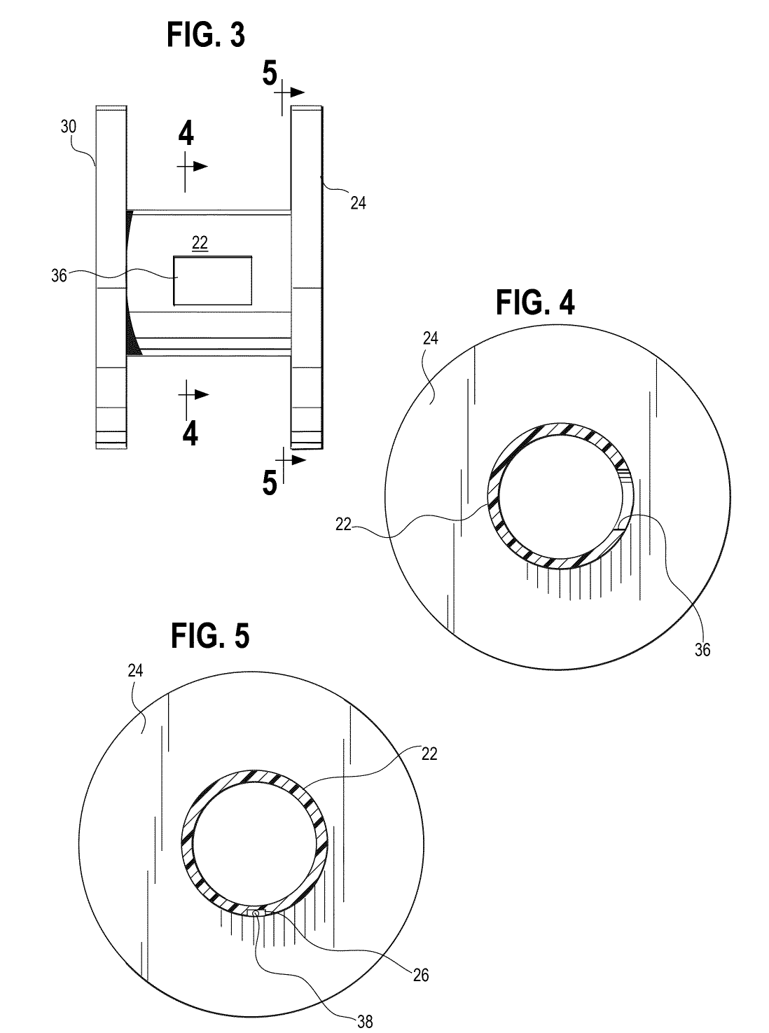

A lighted surround is provided for a door handle assembly, and can either be configured for being positioned adjacent a door or a sleeve that extends around a knob or handle of the door handle assembly. Examples of such lighted surrounds and components thereof are described herein and depicted in FIGS. 1-16.

Turning first to a lighted surround for being positioned adjacent a door, as illustrated in FIG. 1, the lighted surround 20 may have a generally cylindrical body 22 defined by a sidewall. Attached adjacent each end of the body is a radially extending flange 24 and 30. Each flange 24 and 30 has an outer diameter larger than the outer diameter of the body 22. The body 22 can be positioned in an opening of a door 8 configured for receiving a door handle assembly 10. When the body 22 is positioned in the opening of the door 8, the flanges 24 and 30 can be positioned on either side of the door 8 and exteriorly thereof, as illustrated in FIG. 2. Face plates 14 of the door handle assembly 10 can then be secured to the door 8, with the flanges 24 and 30 therebetween. Thus, at least the peripheral rims of the flanges 24 and 30 can remain visible after installation of the door handle assembly 10 to the door 8. In an alternative example, only one of the flanges is used and the other flange is eliminated. The body 22 can include an opening 36 in order to permit internal components 16 of the door handle assembly 10 to pass therethrough, such as operating members for a door latch.

In order to illuminate the lighted surround 20, one or more light sources 38 can be positioned in recesses 26 of the flanges 24 and 30 to provide illumination of the flanges 24 and 30. The recesses 26 may be through holes, apertures, cavities and the like. In one example, the recess 26 may be sized to retain the light source 38 once the light source 38 is inserted into the recess 26. The light source 38 can be connected to a power source, such as a battery 32, or may be hardwired to an electrical system. In the example of a battery 32, the body 22 may be configured to permit mounting of the battery 32 at a variety of different locations, such as by using depressions 28 in the interior of the body 22, thereby permitting the position of the battery 32 to be moveable in order to accommodate interior components 16 of the door handle assembly 10, which may differ among door handle assemblies. The battery 32 can be connected to the light source 38 using electrical connections 34, which can either be attached to the body 22, unattached to the body 22 or integral with or embedded within the body 22.

The illumination of the lighted surround 20 can be controlled in a variety of different ways. For example, the lighted surround 20 can always be illuminated, thereby provided a decorative illumination of the door handle assembly 10. The lighted surround 20 can instead be selectively activatable, such as with a switch. The switch can either be manual or light activated. Further, the illumination can be controlled using a system, such as an alarm system or other building system. Moreover, different light sources can be separately controlled, so that different signals can be indicated with the illumination. For example, a red light can indicate not to exit a room, and a green light can indicate that it is acceptable to safely exit. Other types of controls, such as flashing or blinking light sources, can also be used. A temperature sensor can also be incorporated into the lighted surround 20, and a temperature sensor can be positioned on each side of the lighted surround 20. The temperature sensor can indicate whether it is safe to open a door. For example, a green light may indicate that it is safe to open the door, based upon a temperature sensed on an opposite side of the door, and a red light may indicate that the temperature on the other side of the door is too hot and the door should not be opened.

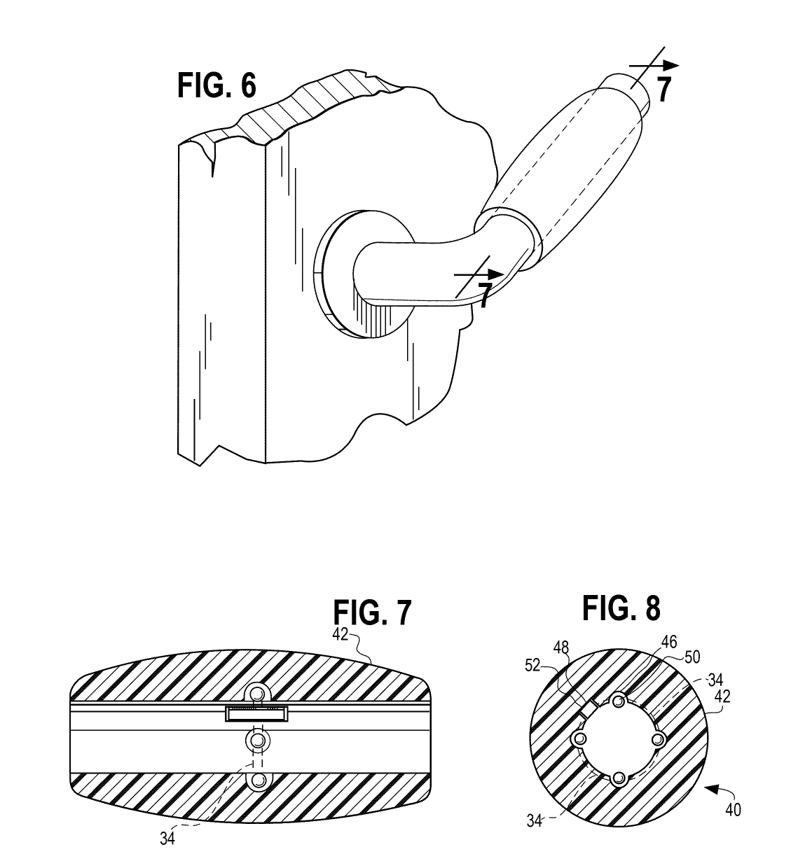

Turning now to the lighted surround in the form of a sleeve, an example of which is illustrated in FIGS. 6-8, the sleeve 40 includes a generally cylindrical wall having a through opening 44 and an outer surface 42. The outer surface may be contoured, as illustrated in FIGS. 6 and 7, and/or may include surfaces irregularities, such as ridges, depressions and the like to facilitate gripping. In the inner surface, recesses 46 and 48 may be formed for receiving a plurality of different light sources 50, as well as an optional battery 52, although the light sources 50 may be hard-wired to an electrical system. The lighting of the sleeve 40 can be controlled in the same manner as described above with respect to the lighted surround for positioning adjacent a door.

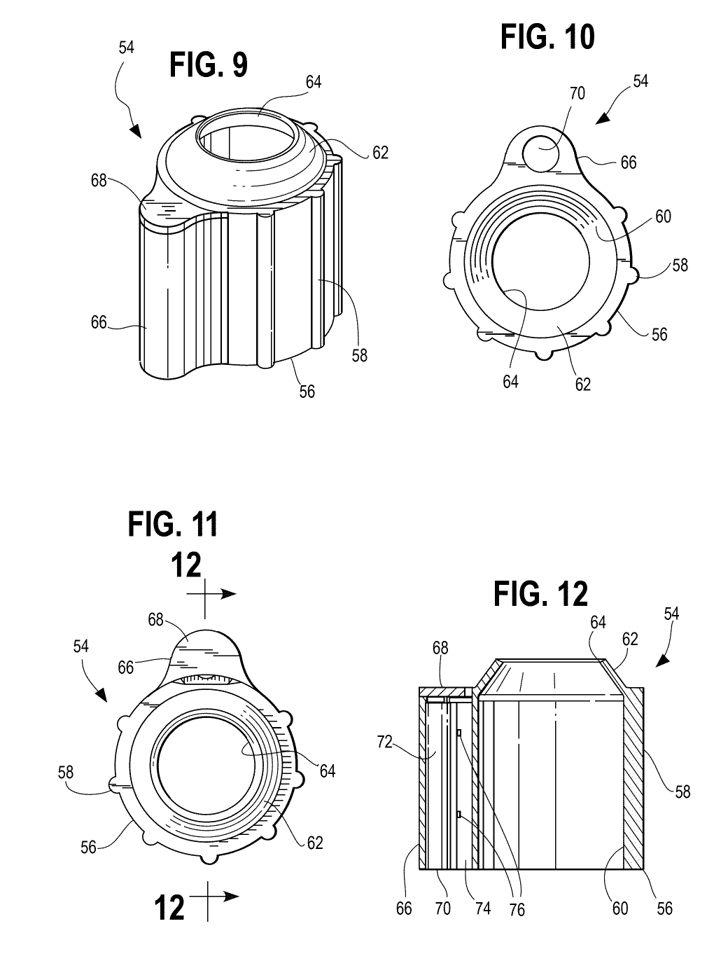

In another embodiment, illustrated in FIGS. 9-16, the lighted surround 54 is dimensioned to fit over the rotatable knob of a door handle, such as a circular knob. As with the proceeding embodiments, the lighted surround 54 for a knob can be made of a translucent, elastomeric material, such as silicone or clear silicone. The elastomeric properties of the lighted surround 54 permit it to be stretched to fit around a door knob, while maintaining a close, generally slip-free fit once in place around the door knob.

The lighted surround 54 includes a closed sidewall 56 with an open bottom end 60 and an open top end 64, as illustrated in FIGS. 9-14. A plurality of outwardly-extending ribs 58 from the sidewall 56 of the lighted surround 54 can optionally be provided to enhance gripping. A compartment 66 for a power source, such as a light, is integrally formed with the unitary lighted surround 54. An outward-facing end of the lighted surround 54, adjacent the open tope end 64, can include a tapered and/or reduced diameter segment 62. A purpose of this segment 62 is to limit the extent to which the lighted surround 54 can be placed over a door knob, while the optional open top end 64 permits access to a keyhole, door lock and the like.

The compartment 66 is preferably disposed outwardly from the sidewall 56, such that the inner surface of the sidewall 56 is not interrupted by the compartment 66 when the inner surface is in contact with a door knob. The compartment 66 includes a bottom wall 70, as illustrated in FIGS. 10, 12 and 14, and an opposite, open top which can be selectively closed using a cover 68. The cover 68 may optionally be of a material more rigid than the material forming the lighted surround 54 and sized with a plug or the like to snuggly fit and be held in place within the top portion of the compartment 66, although other suitable ways of removably attaching the cover 68 relative to the compartment 66 can be used, such as a hinge, adhesive, friction fit or the like.

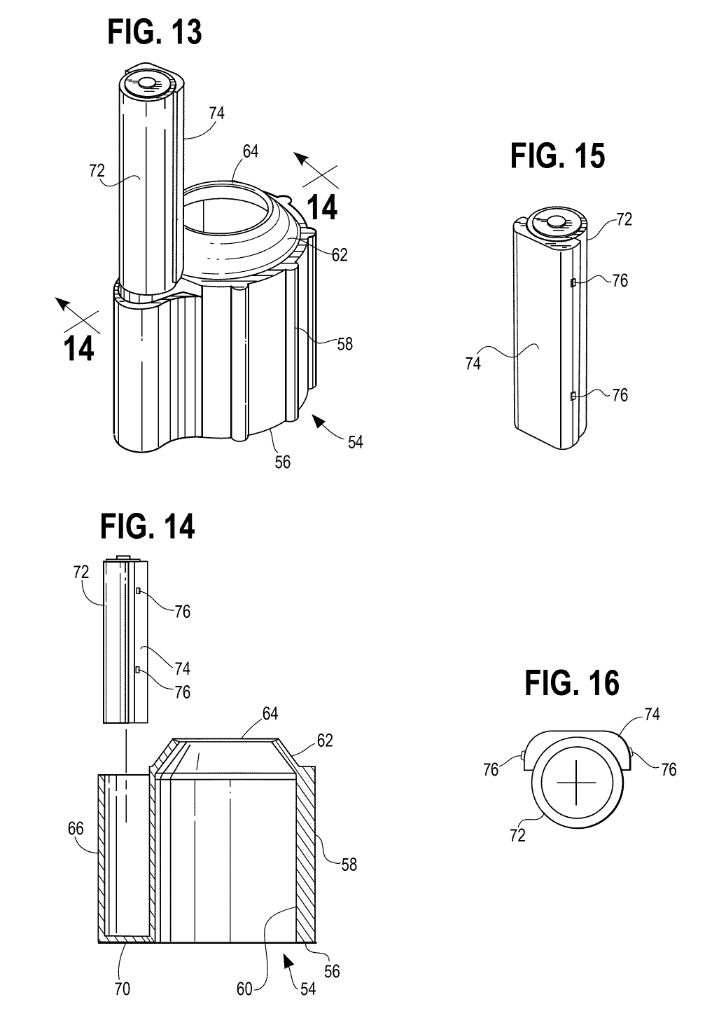

The compartment 66 can be dimensioned to removably accommodate both a power source, such as a battery 72, and a light source. The light source is preferably, though not necessarily, more inwardly-facing than outwardly facing so as to provide greater illumination to the sidewall 56 than if outwardly facing. The light source may be one or more LEDs 76, and they may be carried by a generally rigid light insert 74. The light insert 74 can be dimensioned to snap or snuggly fit against the side of the battery 72, as illustrated in FIGS. 13-16. This can facilitate the battery 72 and attached light insert 74 being inserted into the compartment 66 at the same time. Depending on the size of the compartment 66, the battery 72 and the light insert 74 may be snuggly held in place. The interior of the compartment 66 can be sized to have substantially the same contour as the outer periphery of the battery 72 and the light insert 74. The battery may be a standard size, such as AA or AAA. Electrical connections between the LEDs 76 and the battery 72 may be made using conductive extensions of the light insert 74, at least partially embedded or otherwise attached conductive elements disposed in the inner surfaces of the compartment 66 and cover 68, or combinations thereof.

The drawings and the foregoing descriptions are not intended to represent the only forms of the lighted surrounds in regards to the details of construction. Changes in form and in proportion of parts, as well as the substitution of equivalents, are contemplated as circumstances may suggest or render expedient.

1. A lighted gasket for use with a door handle assembly, the lighted gasket comprising:
a generally cylindrical body portion having a sidewall with an outer diameter and an inner diameter and an opening in the sidewall of the body portion permitting passage of one or more components of the door handle assembly;
a flange extending radially outwardly from a first end portion of the body portion, the flange having an outer diameter larger than the outer diameter of the body portion, a thickness, a generally planar outer facing surface and a generally planar inner facing surface, a recess in the flange for receiving a light source for illumination of the flange; and
wherein the body portion and flange are integrally formed of a flexible, elastomeric material that is at least partially translucent.

2. The lighted gasket of claim 1, wherein a first light source is positioned at least partially in the recess of the flange for illumination of the flange.

3. The lighted gasket of claim 2, wherein a battery is provided for powering of the light source.

4. The lighted gasket of claim 3, wherein the sidewall of the body has a plurality of receptacles for an inwardly protruding battery configured to permit the battery to be selectively attached to one of the receptacles to position the battery out of the way from one or more components of the door handle assembly positioned at least partially within the body.

5. The lighted gasket of claim 2, wherein a light-detector controls illumination of the light source.

6. The lighted gasket of claim 2, wherein the light source is adapted to be connected to an alarm system to control illumination of the light source.

7. The lighted gasket of claim 2, wherein a second recess is provided in the flange for receiving a second light source, the second light source having a different illumination property than the first light source.

8. The lighted gasket of claim 1, wherein a second flange extends radially outwardly from a second end portion of the body portion, opposite the first end portion, the second flange having an outer diameter larger than the outer diameter of the body portion, a thickness, a generally planar outer facing surface and a generally planar inner facing surface.

9. The lighted gasket of claim 8, wherein a recess is provided in the second flange for receiving a light source for illumination of the second flange.

10. The lighted gasket of claim 8, wherein a first light source is positioned at least partially in the recess of the flange for illumination of the flange.

11. The lighted gasket of claim 10, wherein a battery is provided for powering of the light source.

12. The lighted gasket of claim 11, wherein the sidewall of the body has a plurality of receptacles for an inwardly protruding battery configured to permit the battery to be selectively attached to one of the receptacles to position the battery out of the way from one or more components of the door handle assembly positioned at least partially within the body.

13. The lighted gasket of claim 10, wherein a light-detector controls illumination of the light source.

14. The lighted gasket of claim 10, wherein the light source is adapted to be connected to an alarm system to control illumination of the light source.

15. The lighted gasket of claim 10, wherein a second recess is provided in the flange for receiving a second light source, the second light source having a different illumination property than the first light source.

16. A lighted sleeve for use with a door handle, the lighted sleeve comprising:
a body having an elastomeric sidewall configured to stretch to accommodate a door handle therein;
a recess in the sidewall for receiving a light source to illuminate at least a portion of the sidewall and a light source received in the recess; and
means for illuminating the light source.

17. The lighted sleeve of claim 16, wherein means are provided for controlling illumination of the light source.

18. A lighted surround for use with a door knob, the lighted surround comprising:
an elastomeric, closed sidewall having a pair of opposite open ends, one of the open ends having a smaller cross-sectional area than the other of the open ends;
an elastomeric battery compartment integrally formed with the sidewall and extending outwardly therefrom, the battery compartment having a closed end and an open end; and
a light insert configured to be inserted into the battery compartment along with a battery, the light insert including at least one light source operably connectable to a battery for illuminating the lighted surround.

19. The lighted surround of claim 18, wherein a cover is selectively operably to close the open end of the battery compartment.

20. The lighted surround of claim 18 in combination with a battery, wherein the light insert is configured to abut against the battery and sized to removably fit with the battery in the battery compartment.
